(19) United States
(12) Patent Application Publication
(10) Pub. No.: US 2018/0042188 A1
(43) Pub. Date: Feb. 15, 2018

(54) APPARATUS AND METHOD FOR CONTROLLING IRRIGATION PROCESS BY SENDING ENCODED MESSAGES ALONG IRRIGATION CONDUIT

(71) Applicant: Rainboxx, Inc., Austin, TX (US)

(72) Inventors: Alex KHABBAZ, Austin, TX (US); Steve Cratus OWENS, Barrington, NH (US); Michael VARANKA, Amherst, NH (US); Karl KARASH, Berlin, MA (US)

(21) Appl. No.: 15/673,702

(22) Filed: Aug. 10, 2017

Related U.S. Application Data
(60) Provisional application No. 62/372,884, filed on Aug. 10, 2016.

(51) Int. Cl. A01G 25/16; H04B 11/00; B05B 12/00; G05D 7/06; B05B 12/06

(52) U.S. Cl. CPC A01G 25/16; G05D 7/0641; B05B 12/06; B05B 12/006; H04B 11/00; F16K 31/0675

(57) ABSTRACT

An irrigation system having a user interface, a master valve, at least one conduit coupling the master valve with at least one slave valve; and a communication system for wirelessly communicating operating instructions between the master valve and the at least one slave valve. The medium of the communication system, for transmitting instructions, is located along the conduit.

### FIELD OF THE INVENTION

The present invention relates to irrigation systems in which the one or more irrigation zones are controlled by pressure pulse signals which are communicated directly through the irrigation water contained within the conduits of the irrigation system

### BACKGROUND OF THE INVENTION

Irrigations systems have been designed around the concept of a control box or a controller and a valve box. The control box or a controller turns “on” and “off” each of the solenoid valves in the valve box at desired time intervals. The input of each valve is connected to the water supply line. The output of each valve is connected to downstream pipes or conduits that meander or run through the corresponding irrigation zone.

Most systems must utilize a plurality of slave valves in which each slave valve controls a separate watering zone that has a plurality of sprinkler heads located along a conduit which extends within the respective watering zones. Due to the frictional flow losses within the distribution pipe or conduit that restrict the volume of water that can be delivered, if all the sprinkler heads were activated at the same time (i.e., simultaneously supplied with water pressure), the delivered water pressure for each sprinkler head would vary accordingly. That is, the frictional flow losses would cause the delivered water pressure for the downstream sprinkler heads to generally be insufficient. Thus, the sprinkler system would fail to operate as designed, e.g., the associated sprinkler heads would insufficiently water all of the designated areas to be watered.

In an attempt to address this, systems were designed having a plurality of slave valves, in which each slave valve controls a plurality of sprinkler heads of a respective watering zone. However, in order to provide such control, each slave valve needs electronic wiring and thus, each slave valve cannot efficiently be located near each respective zone. However, since the slave valve must be located proximate to the controller, a large amount of additional trenches and distribution pipe or conduit must be installed in order to complete the irrigation system. The Inventors noted that if the valves could be mounted remotely or adjacent the watering zone, a substantial amount of trenching and distribution pipe or conduit could be saved thereby reduce overall cost of install for an irrigation system.

In addition, the Inventors also noted that if the plurality of (slave) valves were able to communicate with the main controller in a wireless fashion, this would minimize the electrical wiring required for installation of an irrigation system and further reduce the overall cost of installing an irrigation system.

### SUMMARY OF THE INVENTION

Wherefore, it is an object of the present invention to overcome the above mentioned shortcomings and drawbacks associated with the prior art.

Another object of the present invention is to provide an irrigation system having: a user interface; a master valve; a conduit extending between the master valve and at least one slave valve; and a wireless communication system for communicating instructions between the master valve and slave valve; wherein a medium of the communication system, for transmitting instructions, is located along the conduit.

A further object of the present invention is to provide a method of irrigating, the method comprising: providing a plurality of slave valves, controlling a plurality of sprinkler heads of a respective watering zone; locating each of the plurality of slave valves near each respective zone; facilitating communication between the slave valves and a main controller in a wireless fashion; and minimizing a required amount of electrical wiring for installation of an irrigation system and thereby further reducing the overall cost of installing an irrigation system.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. The invention will now be described, by way of example, with reference to the accompanying drawings in which:

FIG. 1 is a diagrammatic drawing showing an improved irrigation system according to the present invention;

FIG. 2 is a diagrammatic drawing showing another embodiment of an improved irrigation system according to the present invention;

FIG. 3 is a diagrammatic drawing showing a further embodiment of an improved irrigation system according to the present invention;

FIG. 4 is a diagrammatic drawing showing the features of the irrigation control box and irrigation controller according to the present invention;

FIG. 5 is a diagrammatic drawing showing another embodiment of an irrigation control box and irrigation controller according to the present invention;

FIG. 6 is a diagrammatic drawing showing the features of the latching solenoid slave valve according to the present invention;

FIGS. 7-13 are diagrammatic illustrations of alternative components of the latching solenoid slave valve according to FIG. 6;

FIG. 14 is a diagrammatic drawing showing another embodiment of an improved slave valve according to the present invention;

FIG. 15 is a diagrammatic drawing showing a further embodiment of an improved slave valve according to the present invention;

FIG. 16 is a diagrammatic drawing showing a further embodiment of an improved slave valve and removable cap according to the present invention;

FIG. 16A is a diagrammatic drawing showing a side view of the removable cap with seal and threading engagement according to the present invention;

FIG. 16B is a diagrammatic drawing showing the bottom view of the removable cap with an integrated power source according to the present invention;

FIG. 17 is a diagrammatic drawing showing a possible communication flow chart for the software employed with the present invention;

FIG. 18 is a diagrammatic diagram showing a possible pulsing scheme for actuating a further latching solenoid slave according to the present invention; and

FIGS. 19-19A are each part of a two-part diagrammatic drawing showing possible associated flow logic for possible software of the present invention.

It should be understood that the drawings are not necessarily to scale and that the disclosed embodiments are sometimes illustrated diagrammatical and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE PREFERRED EMBODIMENTS

The present invention will be understood by reference to the following detailed description, which should be read in conjunction with the appended drawings. It is to be appreciated that the following detailed description of various embodiments is by way of example only and is not meant to limit, in any way, the scope of the present invention.

Sensing, Connection & Coupling Technologies

Generally, the limiting factor in inexpensively and reliably connecting a master controller to the necessary down-stream sensing and decoding electronics of a slave valve is the physical connection between them. Assembly of individual wires is expensive. Connectors are both expensive and unreliable. A means to eliminate a direct, manufactured connection between a controller and the down-stream sensing and decoding electronics of respective slave valves is beneficial from the perspective of both cost and reliability.

It should be clear that, although every combination of sensor, controller, signal generator, down-stream sensing and decoding electronics connection, technique and fluid path coupling method, is not articulated, many of the approaches described can be implemented in one or more combinations. It is not the intent of this disclosure to fully discuss each of these viable configurations—but merely to briefly represent various aspects thereof. It is to be recognized that various situations will result in a wide variety of limiting factors and these configurations may be altered in accordance with these limiting factors.

As many of the features of the various configurations and embodiments are similar and/or are functionally equivalent, identical reference numbers are given to similar element when possible.

Wireless Irrigation System: Branching

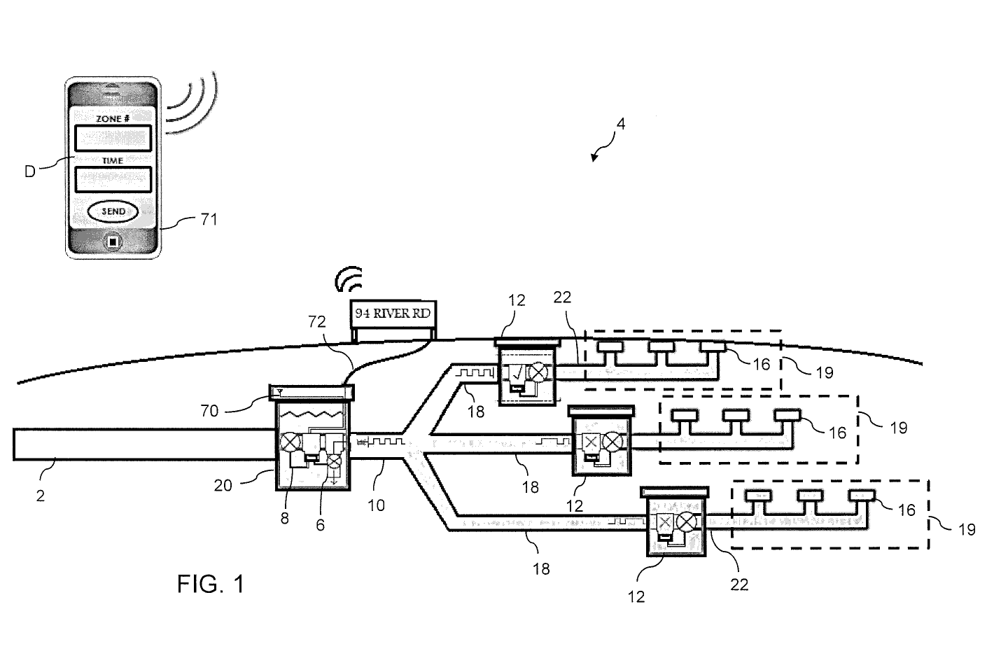

Turning now to FIG. 1, a brief description concerning the various components according to a first embodiment of the present invention will now be briefly discussed. As shown in FIG. 1, the main components of the irrigation system 4 of the present invention are: a water supply source 2, a control box 20 with a main (master or pulser) valve 6 and a controller 8, a water distribution conduit 10, at least one slave valve 12 (three of which are shown in FIG. 1), and at least one sprinkler head 16 (three of which are shown for each zone 19 in FIG. 1).

As generally shown in FIG. 1, the irrigation system 4 includes the main water distribution conduit 10 which has a first end thereof fluidly coupled, via the main control box 20, to the water supply source 2. It is noted that while the water supply source 2 is generally a public or private water supply, (e.g., a well), any water supply source 2 is conceivable so long as such a source is capable of supplying pressurized water to the irrigation system 4.

As shown here, a first embedded antenna 70 and a possible second external antenna 72, allow the irrigation system 4 to receive instructions wirelessly from the user interface D. As shown in FIG. 1, such a user interface may include computer readable medium employing a digital application for remote controlling thereof by any wireless carrier.

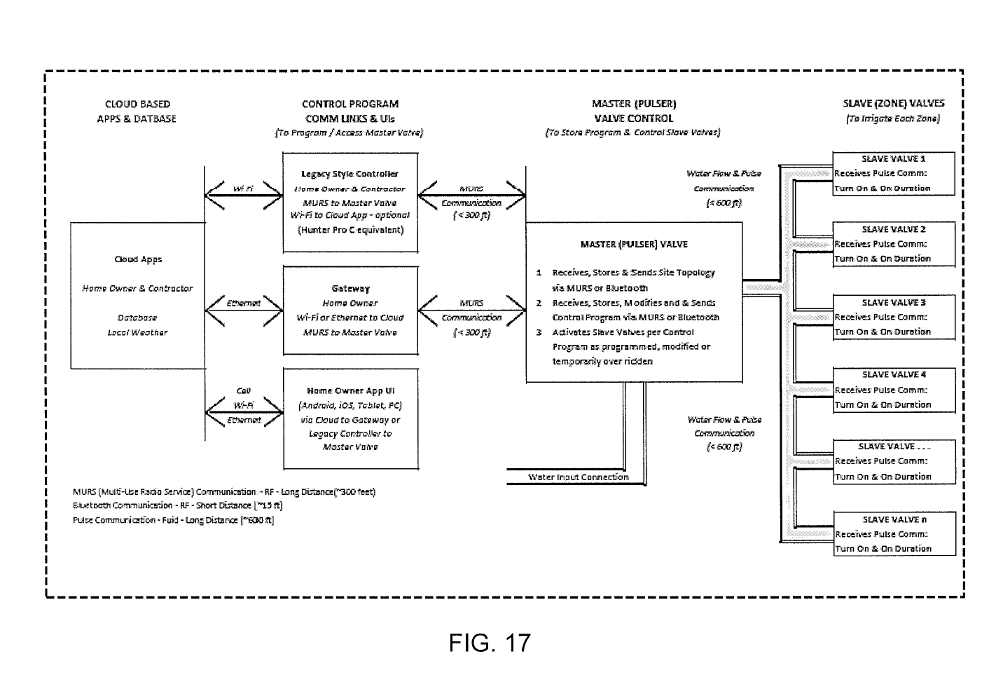

Generally, the main control box 20 houses both the pulser valve 6 and the irrigation controller 8. However, it is to be appreciated that separate housing is possible, so long as the irrigation controller 8 is still electrically connected to the pulser valve 6, and the pulser valve 6 is still connected to the water supply source 2. The pulser valve 6 is capable of discharging water, for a very short duration of time, e.g., a fraction of a second, from the water supply source 2 to atmosphere, according to command instructions sent by the irrigation controller 8. Note that any publically available irrigation controller is possible so long as it is electrically connected to the pulser valve 6 for controlling operation of the pulser valve 6 and programmed for causing the pulser valve 6 to transmit acoustical waves or pulses P, described in further detail below with respect to FIGS. 17-19, along the pressurized water contained in the main water distribution conduit 10 of the irrigation system 4.

The main water distribution conduit 10 extends from the main control box 20 and typically branches out into a plurality of separate conduits, branches, fingers or legs 18 which all terminate at a respective latching solenoid slave valve 12 (for the sake of convenience, only three fingers, branches or legs 22 are shown in FIG. 1).

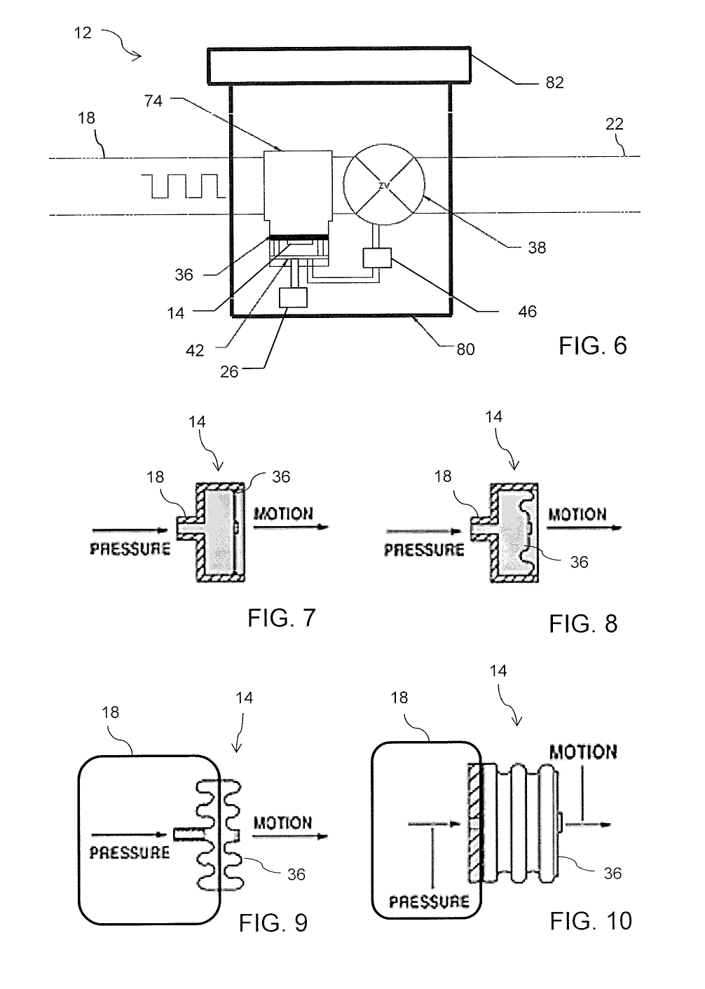

As shown in FIG. 1, each respective latching solenoid slave valve 12 is associated with a plurality of sprinkler heads 16 located in spaced relationship from one another along each respective separate zone distribution conduit 18 of the irrigation system 4 for facilitating watering of a desired area 19 (only diagrammatically shown in FIG. 1). The latching solenoid slave valve 12 receives operating instructions which control operation of each respective latching solenoid slave valve 12 (as discussed in greater detail with respect to FIG. 6). When the respective latching solenoid slave valve 12 is actuated, water is permitted to flow through the respective latching solenoid slave valve 12 to the zone distribution conduit 22 and the associated sprinkler heads 16 for watering of the respective desired area 19.

In this embodiment, the conduit 10 begins to separate into multiple branches 18 which extend a desired distance before reaching the respective slave valve 12. An origin or starting point of each of the branches in FIG. 1 is shown adjacent or proximate to the control valve 6. That is, the branches 18 extend like spokes of a wheel outward from a common connection point of the conduit 10.

While the slave valves 12 may be placed at any distance along or from the beginning of each of the branches 18, the embodiment in FIG. 1 illustrates that each of the slave valves 12 are generally located equidistance from the conduit 10. The benefit of this arrangement is that any signal sent from the master box is received simultaneously by each of the slave valves 12.

Wireless Irrigation System: Branching Continuous Conduit

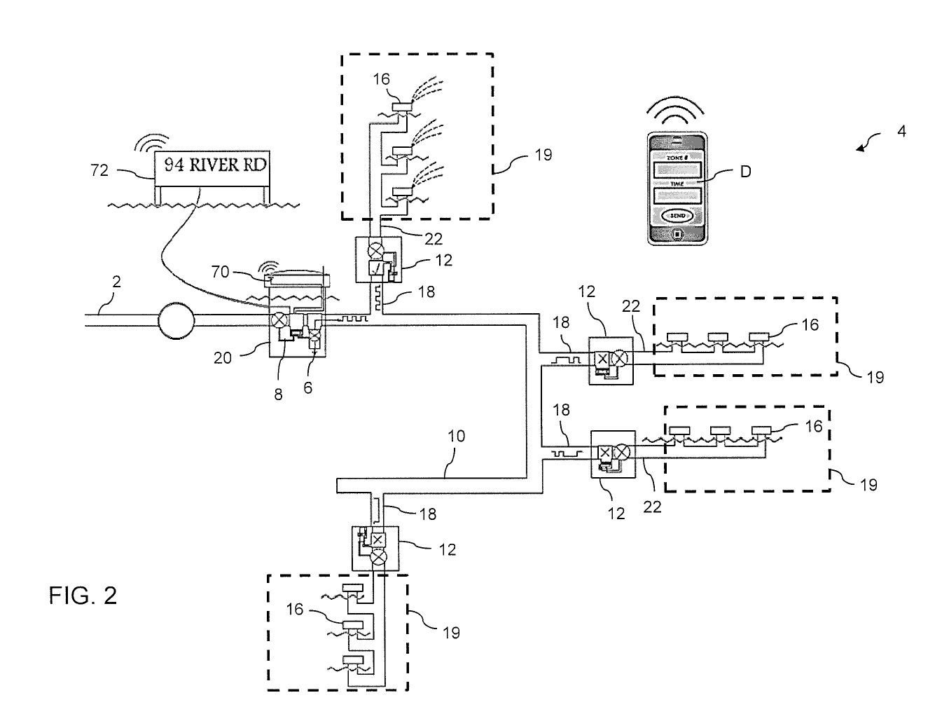

FIG. 2 illustrates a further embodiment of an improved irrigation system 4 according to the present invention. As this embodiment is similar in most respects to the embodiment of FIG. 1, only the differences between the two embodiments will be discussed in detail.

Specifically, this irrigation system 4 provides a single continuous supply conduit 10 with branches 18. That is, contrary to the above embodiment, the single continuous supply conduit 10, shown in FIG. 2, has a first end connected with the master (pulser) valve and an opposed end connected to the third branch, with the first and the second branches 18 located therebetween. That is, the ending of the conduit 10 is not a common origin point of each of the branches 18. Instead, the beginning of each of the branches 18 correspond with a respective, distinct and separate meeting point with the main conduit 10. One of the advantages of such an arrangement is a decrease in the amount of “noise” generated within the single continuous supply conduit 10. This single continuous supply conduit 10 is believed to be less likely to introduce reflections and interactions of a pulse signal associated with multiple extended length branches 18.

While the water supply source 2 is generally a public or private water supply, (e.g., a well), any water supply source 2 is conceivable. However, it is noted that when utilizing a pulser valve, the cost-effectiveness of this system 4 is greatly increased when the source 2 is capable of supplying pressurized water on a continuous basis to the irrigation system 4. In this case, the continuous pressure supplied by the source 2 provides most of the energy for generating the pulses via the pulse valve 6.

Wireless Irrigation System: Continuous Conduit

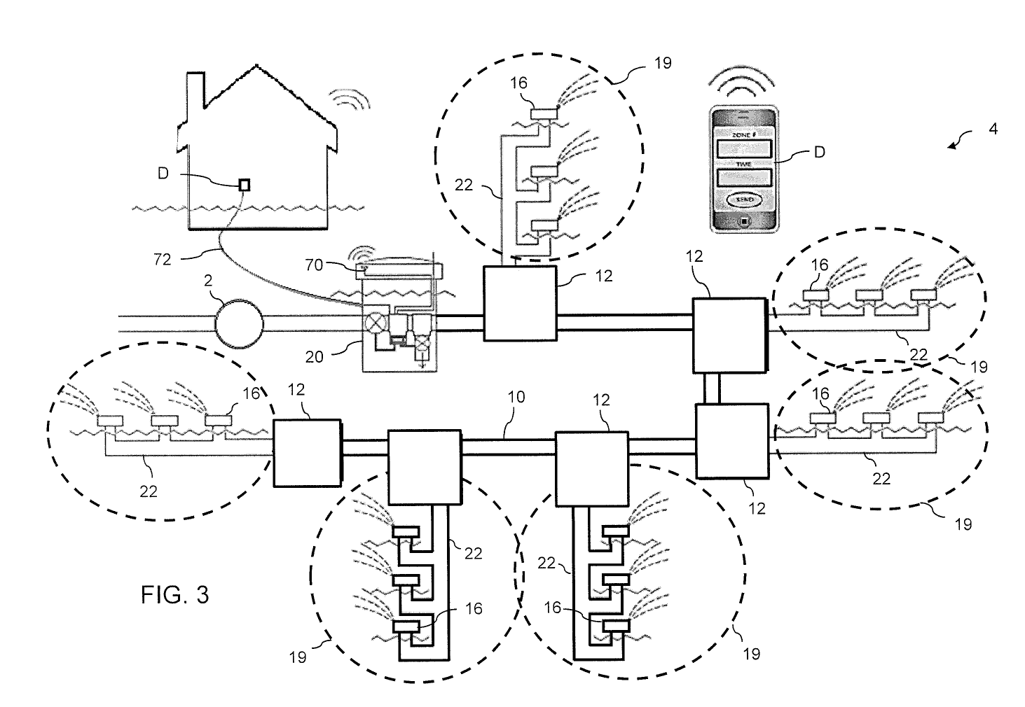

FIG. 3 illustrates another embodiment according to the present invention of an improved irrigation system 4 comprising a continuous water distribution system without any branches 18. Similar to the embodiment shown in FIG. 2, according to this embodiment there is a single continuous conduit 10 which extends from the main water flow valve 6. Unlike the embodiment of FIGS. 1 and 2 however, this embodiment provides a continuous conduit 10 which communicates directly with each of the respective diaphragms of each of the respective slave valves 12. Thus, the conduit 10 extends from the main water flow valve 6 and between the proximate slave valve 12, being closest to the master control 20, and the distal slave valve 12, being furthest along the conduit 10 from the master control 20. As with the embodiment shown in FIG. 2, FIG. 3 provides a continuous conduit 10 which is believed generally less likely to introduce reflections and interactions associated with multiple branches.

As shown in FIG. 3, the water supply source 2 shown here is a public or private water supply, (e.g., a well) associated with the home of a user. Thus, in this embodiment, the main master control box 20 may be connected to a water supply source 2 closely adjacent or within the home.

A further advantageous feature of the embodiment shown in FIG. 3 are the redundant communication methods 70, 72. A first communication method is provided by the first embedded antenna 70 which allows the irrigation system 4 to receive instructions wirelessly from the user interface and display D. As shown here, a second communication method is possible by connecting the control box 20 directly to an interface D in the home via a second external communication line 72. This allows the irrigation system 4 to receive instructions directly from a user interface/display D.

It is noted that an interface display D may have many configurations, e.g., may merely be an electrical or physical interface D or potentially, a connection 72 of the computer readable medium of the irrigation system 4 to a home network. In the latter instance, a cell phone D may be used to access the external connection 72 and the interface D of the master control box 20 via a user's separate antenna, or any internet connection such as LAN, Wi-Fi, cable-network, FIOS, etc. Another advantage of this embodiment is the increased accessibility and capability associated with connecting the computer readable medium of the irrigation system to the home network, i.e., it may be possible to have increased manipulation and monitoring capabilities through an interactive personal computer platform.

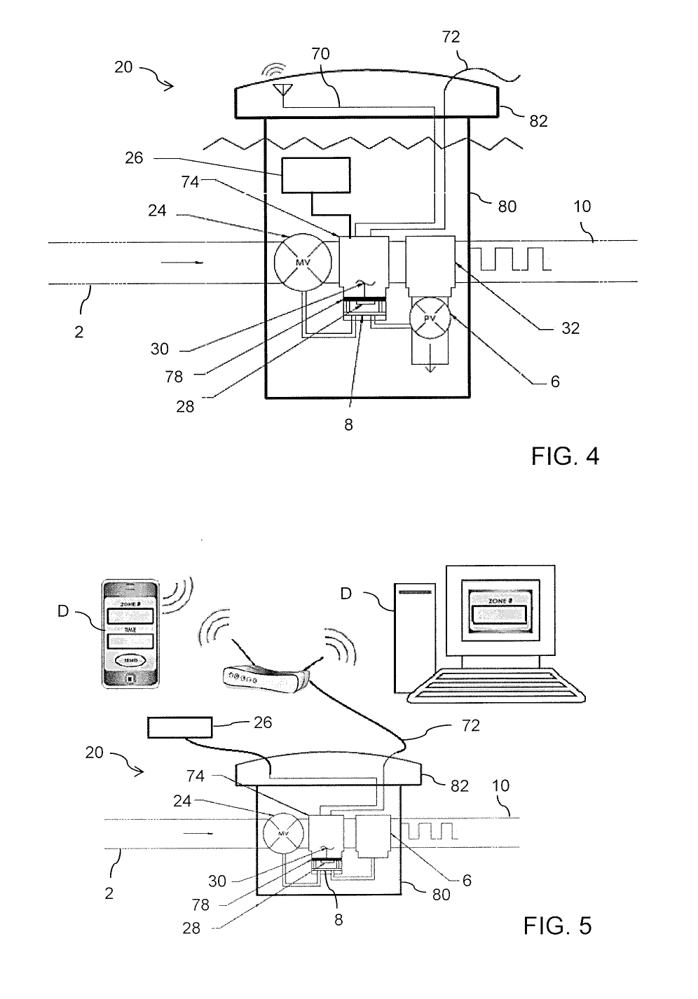

Alternatively, it is possible to provide the entire control box 20 within the home. An internal control box 20 located in the home would generally have an integrated display D on an external surface of the control box 20. Indeed, there are multiple embodiments of each of the various components of the systems which are generally interchangeable. Some of these components will now be discussed in further detail with respect to FIGS. 4-16.

Main Control Box

As generally shown in FIG. 4, the main control box or master valve box 20 typically includes a housing 80, a main water flow valve 24, the pulser valve 6, and the irrigation controller 8. As shown, the irrigation controller 8 is electrically connected to a conventional power source 26, e.g., a wall outlet or a battery, for electrically powering the irrigation controller 8. The irrigation controller 8 is programmed for controlling operation of the irrigation system 4 and is coupled to at least one communication source 70, 72, D, a solenoid operated valve 32 and the pulse generator (or pulser valve) 6.

As shown here, a first tee fitting 74 enables the battery powered printed circuit board assembly (or microprocessor) 8 to be electronically connected to at least a first embedded antenna 70, a second external antenna 72, and various sensors 30, 28 mounted to a sealed diaphragm 78. A waterproof enclosure 80 with cap 82 ensures that all the electronics are sealed inside the main control box 20.

The main water flow valve 24 is fluidly coupled to the water supply source 2, via at least a source supply conduit, and is fluidly coupled to a first inlet end of the main water distribution conduit 10. In addition, the main water flow valve 24 is electrically coupled to the irrigation controller 8 to assist the irrigation controller 8 with controlling operation of the main water flow valve 24 and the flow of water from the water supply source 2 to the irrigation system 4.

Similarly, the pulser valve 6 is typically also fluidly connected to the main water distribution conduit 10 adjacent the first end of the main water distribution conduit 10, but downstream of the main water flow valve 24. The solenoid operated valve 32 of the pulser valve 6 is electrically coupled to the irrigation controller 8 for receiving operating commands for controlling operation thereof.

An outlet end of the solenoid operated valve 32 of the pulser valve 6 is directly vented to the atmosphere, e.g., to an area of the lawn or yard, a flower bed, a garden, or possibly to a septic or a sewage system, for periodically discharging a very small volume of water from the main water distribution conduit 10. When the irrigation controller 8 issues a command instructing the pulser valve 6 to “open” the associated solenoid operated valve 32, pressurized water is permitted to flow from the water supply source 2 into and along a small section of the main water distribution conduit 10 and out through the associated the pulser valve 6 where such water is directly or indirectly vented to the atmosphere. As a result of such water flowing through the pulser valve 6, a pressure drop immediately occurs at the associated solenoid operated valve 32 and this pressure drop, in turn, creates an acoustical wave or pulse P in the water contained within the main water distribution conduit 10.

Shortly after the irrigation controller 8 issues the command instructing the associated solenoid operated valve 32 of the pulser valve 6 to open, thereafter the solenoid operated valve 32 of the pulser valve 6 closes. Such closure again interrupts the flow of water from the water supply source 2 out through the pulser valve 6 to the atmosphere. Rather than separate and discrete open and close commands associated with the master and slave latching valves, the associated solenoid operated valve 32 of the pulser valve 6 is controlled by a single electrical pulse of the duration specified, e.g., 25 to 100 milliseconds.

Typically, at least one of a water pressure detecting device 28, e.g., a pressure meter or pressure transducer, and/or a water flow meter 30 is located downstream of the main water flow valve 24. The water pressure detecting device 28 and/or the water flow meter 30 are electrically coupled to the irrigation controller 8 for respectively providing water pressure and water flow information to the irrigation controller 8 for use in controlling operation of the irrigation system 4.

Main Control Box: In Home Systems

Generally shown in FIG. 5, is a possible configuration for the main control box 20 near or in a home or other dwelling. As shown here, the waterproof housing 80 with waterproof sealed cap 82 encompasses the pulse generator 6, the irrigation controller 8, the main water flow valve 24 and a first tee fitting 74 with various sensors 30, 28 mounted on a sealed diaphragm 78. However, it is to be appreciated that the main water flow valve 24 and the first tee fitting 74 with various sensors 30, 28 may be housed separately or not at all, so long as the irrigation controller 8 is connected thereto. Indeed, the connection may be electrical, or it may be via computer programmable medium (i.e., through a computer program or other software which is capable of incorporating the data accordingly), so long as the irrigation controller 8 is connected appropriately for controlling operation of the irrigation system 4.

As shown in FIG. 5, the irrigation controller 8 is electrically connected to a conventional power source 26, e.g., a wall outlet, for electrically powering the irrigation controller. The irrigation controller 8 is also electrically connected to a home network via an external communication line 72 so as to be capable of remote wireless and/or cable based communication with various user interfaces D with various types of displays.

Main Control Box: Audible Signal Transmission

The embodiment in FIG. 5 also illustrates another capability provided by locating the main control box near a constant supply source 26. Specifically, this embodiment also illustrates the possibility of providing an alternative signal provider 6 which is also electrically connected to the controller 8. That is, according to the present invention, the method of using oscillating patterns to signal various controllers through the conduit medium, the signals themselves do not necessarily have to be provided via pressure (i.e., he pulser valve 6). It is also possible to use a series of purely audio pulses transmitted through the conduit 10 itself to transmit the necessary data. Essentially, this means that an oscillator or equivalent frequency generating source 6 in the master control box 20 replaces the pulser valve 6 to transmit messages.

Using this or a related technique, the frequency based audible device 6 generates a short burst of a fixed frequency signal into the fluid. Data can be encoded in the time domain (as with other embodiments, discussed in greater detail with regard to FIGS. 17-19A). However, by providing a signal which may vary with frequency, data may also be encoded in the frequency domain. In this manner, different frequencies would have different meanings, e.g., different frequencies can represent different numerical values representing zone valve addresses and/or irrigation time periods. The advantage of this technique is that messages can be sent more quickly than exclusively using the time domain.

Main Control Box: Optical Signal Transmission:

Similarly, it is also possible to use a series of optical pulses transmitted through the conduit 10 to transmit data, using light transmitters 6 in conjunction with light detectors and/or fluorescent or phosphorescent materials and associated detectors 14. This means that an optical generating source 6 in the master box 20 can replace the pulser valve 6 to transmit messages. Using this technique, the frequency based visual device 6 generates an optical signal in the fluid or along the conduit. Again, the benefit of this arrangement is optimized when providing power 26 at the master box 20 is not a limiting factor. Again, data can be encoded in the time domain as well as in the frequency domain. The advantage of this technique again, is that messages can be sent more quickly than exclusively using the time domain. Furthermore, so long as any potential shift in frequency is accounted for, this embodiment may also provide more accurate readings regardless of air pockets which may develop and otherwise hinder transference of a pressure based pulse.

Slave Valve: Various Configurations

Various embodiments and configurations associated with the slave valve 12 and methods of communicating and detecting will now be briefly discussed referring to FIGS. 6-16. One of the primary challenges of wireless communication from a master to multiple zone valves, through the fluid contained in a conduit, is detecting the communication signals. One alternative embodiment of this invention provides a sensor 14 directly in the fluid path in the conduit 10. However, this approach is typically more expensive and less reliable than external sensing, e.g., on an opposing side of a waterproof sealed diaphragm 36.

Consequently, most of the following alternative embodiments are focused on techniques to inexpensively and reliably detect a signal conducted through a fluid conduit 10 using sensing technologies and techniques that do not directly expose the sensor 14 to the fluid. Some of the following embodiments employ a diaphragm as a coupling vehicle 36 between the fluid and the sensor. Others utilize an alternative coupling technique that also provides reliable and inexpensive coupling—or another sensor and/or signal device altogether.

Slave Valve: Pressure Diaphragm

As discussed above and as generally shown in FIG. 1, each one of the fingers or legs 18 of the main water distribution conduit 10 terminates at a respective slave valve 12. As further discussed with respect to FIG. 6, a tee fitting 74 enables the fluid medium within the branch conduit 18 to be directly connected to both a diaphragm 36 and a latching solenoid latching valve 38. The slave latching solenoid valve 38 of the slave valve 12 separates each one of the branching conduits 18 of the main water distribution conduit 10 from a further distribution conduit 22 of respective zones 19.

The tee fitting 74 is shown here as enclosed within another waterproof enclosure 80 with a waterproof sealed cap 82. This ensures that all the electronics associated with the slave valve 12 are sealed safely within from dirt and other environmental exposure. As shown here, the tee fitting 74 also enables the printed circuit board assembly (or microprocessor) 42 to be electronically connected to at least the sensor 14 on the diaphragm 36, the driver 46 of the slave latching valve 38, and the battery or other power source 26 which may power one or all of these.

Each associated pulse receiver and/or diaphragm 36 is provided for receiving operating instructions which control operation of each associated latching solenoid slave valve 38. Each latching solenoid slave valve 38 is connected so that the respective diaphragm 36 is located upstream and is in constant and continuous direct communication with the pressurized water contained within a respective finger or leg 18 of the main water distribution conduit 10 of the irrigation system 4.

Slave Valve: Direct Pressure Sensing

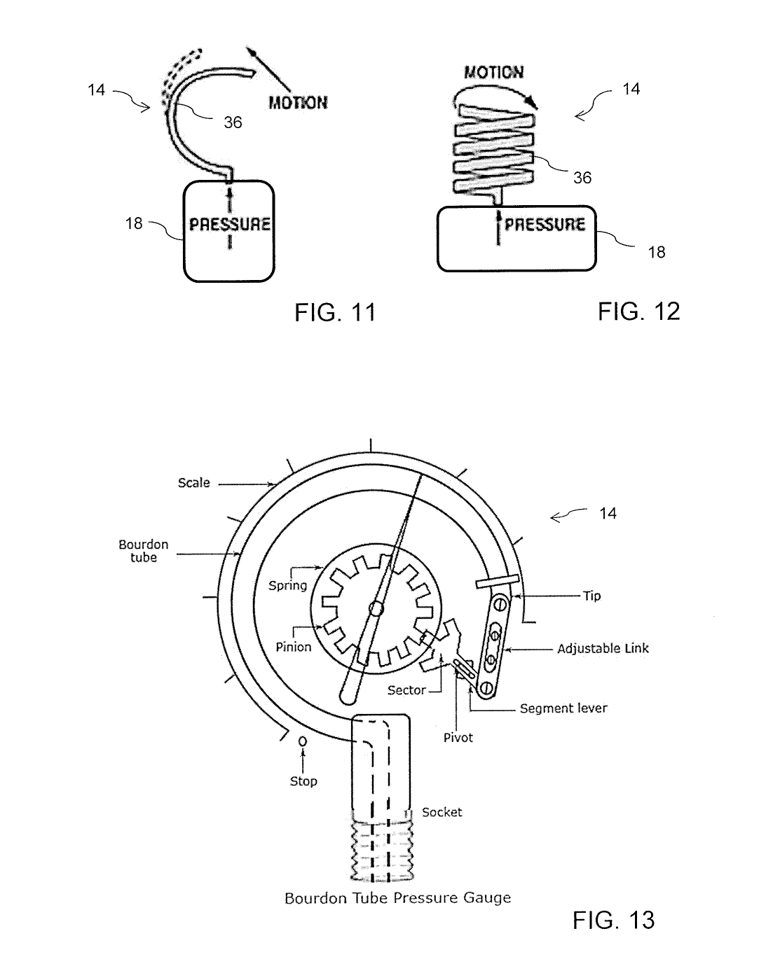

Turning now to FIGS. 7-16B, a brief description concerning the various alternatives of the slave valve 12 according to the present invention will now be provided. As before, an acoustic wave transmitted through the fluid of the irrigation conduit 10 is the direct result of a pressure drop in the conduit 10. However, it is to be appreciated that there are several means or devices 36 which are capable of coupling the pressure drop within the conduit 10 to a sensing device 14 (other than a diaphragm with a sensor as discussed above). FIGS. 6-13 show that the basic pressure sensing element can be configured as a flat diaphragm (FIGS. 6, 7); a convoluted or irregular diaphragm (FIG. 8); a capsule (FIG. 9); a set of bellows (FIG. 10); C-shaped bourdon tube (FIGS. 11, 13); a helical bourdon tube (FIG. 12); and/or equivalent device to illustrate techniques known to the Inventor as being capable of translating pressure into linear motion according to the present invention.

Specifically, a bourdon tube, as shown in greater detail in FIG. 13, consists of a hollow tube that is formed from materials with elastic or spring properties formed in a semi-circular or spiral shape. Increasing the amount of pressure inside the tube causes the semi-circular or spiral shape to unwind or open relative to its current shape. Conversely, decreasing the amount of pressure inside the tube causes the semi-circular or spiral shape to wind up or close. Directly connecting a bourdon tube to the fluid path, i.e., the conduit 10, results in tube motion, i.e., opening or closing, when the fluid pressure changes. The range of motion provided by a bourdon tube is greater than that associated with a diaphragm, making the acoustic wave easier to detect.

In addition to the diaphragm and the bourdon tube briefly discussed above, there are many other technical and/or physical sensors by which the change in pressure within the conduit 10, 18 may be monitored or detected. For example, any conventional motion provider and sensing means 14 may be employed interchangeably, e.g., an accelerometer, a mechanical switch, an electronic switch, an optical sensor, an optical encoder, and a magnetic sensor, etc.

Slave Valve: Pressure Sensitive Fabric/Paint Applied to Diaphragm

Pressure sensitive material, paint or fabric can be directly applied to the mechanical element 36 that correlates pressure with linear displacement. Consequently, a pressure change within the conduit 10, 18 can be detected by the sensor 14 sensing an electrical change across the pressure sensitive material 36 in response to a pulse.

Slave Valve: Spring Loaded Connector

Any number of low cost, non-precision electrical contact techniques for the down-stream electronics can be used, e.g., pogo-pins, to connect the pressure sensitive material 36 contacts to the down-stream sensing electronics 42.

Slave Valve: Magnet & Hall Sensor

A magnet and hall effect sensor can be employed to wirelessly convey motion of the diaphragm, bourdon tube or other mechanical element to the down-stream sensing electronics. Changes of the field strength between a magnet mounted on the diaphragm in response to its motion can be wirelessly detected by a hall effect sensor integrated on the down-stream sensing electronics.

Slave Valve: Linear Potentiometer

Direct mechanical coupling of the diaphragm, bourdon tube or other mechanical element to a linear potentiometer, encoder, etc. can also be used to eliminate wiring and electrical connections between the pulse to a displacement device.

Slave Valve: Co-Location: Accelerometer and Electronics

One of the disadvantages of using an accelerometer attached to a diaphragm to detect the pressure change and associated acoustic wave is that electrical connections are required from the accelerometer to the down-stream sensing electronics that are required to supplement the accelerator. Eliminating these extraneous electrical connections can be achieved by mounting the accelerometer and all of the down-stream sensing electronics directly on the diaphragm. This eliminates the connections and associated manufacturing costs and reliability challenges created by the use of external connections and wiring.

Slave Valve: Displacement Activation of Pressure Sensitive Fabric/Paint

One of the disadvantages of attaching anything directly to a diaphragm to detect pressure changes and associated acoustic waves is that their mass and orientation can adversely affect the magnitude and quality of signal detected. Eliminating these factors can be achieved by removing the accelerometer and all of the down-stream sensing electronics from the diaphragm. This can be accomplished by using the mechanical motion of the diaphragm, the bourdon tube or whatever mechanical device is used to translate pressure change to motion to directly activate an electrical switch or a sensing device that is integrated with the down-stream sensing electronics.

The motion of the diaphragm, the bourdon tube, etc., can be used to mechanically complete a circuit by activating a switch or breaking an optical path. Alternatively, the motion can be used to directly translate the diaphragm pressure directly to a pressure-sensitive paint or fabric. Under the static state, i.e., inactive state, fluid pressure is translated into a fixed voltage using the pressure-sensitive material. Since the pressure change in the fluid associated with an acoustic pulse is directly coupled to the pressure-sensitive material, this change can be detected as a change in the voltage across the pressure sensitive material. Locating the pressure sensitive material on the circuit board along with the down-stream sensing electronics eliminates the need for any wiring. The sensing required to differentiate an acoustic pulse from the normal, non-pulsed, pressure, can be sufficient so that the mechanical tolerances in this assembly can be low resulting in an inexpensive pressure sensing assembly.

Slave Valve: Sensing Audible Component of Physical Pulse

The pulse traveling through the fluid in the conduit has an associated audible component which can be detected using a microphone or other audio sensing device using well established technology and techniques. The audio sensor/transducer must be coupled to the conduit or to a diaphragm or other rigid element that is in contact with the fluid in the conduit.

In addition to (or alternative to) detecting a pressure pulse, a microphone or other audio sensing device can also be used to detect a series of audio pulses transmitted through the fluid in the conduit. Using this technique, the frequency based master pulsing device generates a short burst of a fixed frequency signal into the fluid. The zone valves, each outfitted with a microphone or equivalent frequency sensing device, detect the bursts. Data can be encoded in the time domain as is done with the pressure induced pulses.

Slave Valve: Alternative Devices in a Continuous Conduit Topology

As discussed above, each one of the shorter branches 18 of the main water distribution conduit 10 may terminate at a respective slave valve 12. When a continuous conduit topology is employed (e.g., FIG. 3), slave valves 12 may be connected to the conduit 10 using tee fittings 74 at appropriate points along the conduit 10 for each irrigation zone 19. Thus, the branches 18 may merely be the associated conduit leg connection of the respective tee fitting 74.

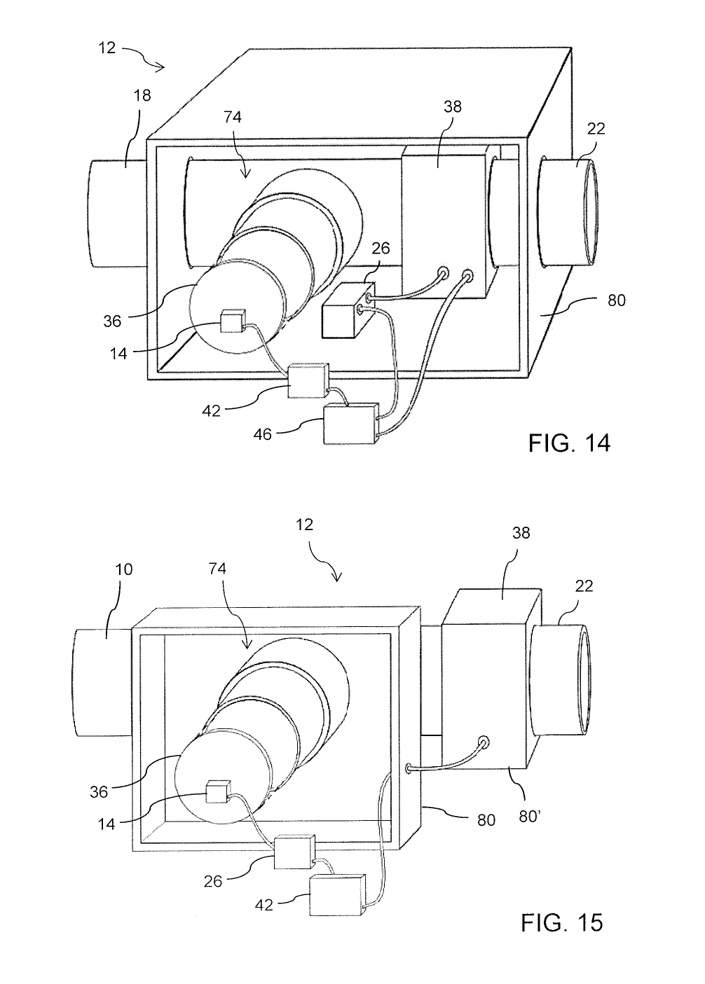

One possible method of providing this assembly 12 is shown in FIG. 14. As before, similar/identical features are provided with the same reference numbers. The tee fitting 74 is shown here as fully enclosed within a waterproof enclosure 80 (waterproof sealed cap 82 is removed in this partially exploded view). This ensures that all the electronics 14, 42, 8, 26, associated with the slave valve 12, are safely sealed within the enclosure from dirt and other environmental elements.

As also discussed above, the present invention is not limited to use of pressurized pulse generators 6, as it is possible to have audible pulse generators 6 instead. In this case, each of the zone valves 12 are outfitted with a microphone or equivalent frequency sensing device 14 mounted on a connecting feature 36 which directly interacts with the medium in the conduit 10, 18. The microphone 14 in turn communicates with the controller 42 either directly or via an amplifier.

Slave Valve: Further Alternatives in a Continuous Conduit Topology

As shown in FIG. 15, and as briefly discussed above, the main water distribution conduit 10 may communicate directly with a respective slave valve 12. When a continuous conduit topology is employed, slave valves 12 may be connected to the conduit 10 using tee fittings 74 at appropriate points along the conduit 10 for each irrigation zone 19.

One possible method of providing this assembly is shown in FIG. 15, and again similar features are provided with similar reference numbers. Specifically shown here, only a part of the tee fitting 74 is enclosed within a waterproof enclosure 80 (waterproof sealed cap 82 is removed in this partially exploded view). The housing 80 ensures that all the electronics associated with the zone valves 12 are sealed safely within from dirt and other environmental exposure.

The latching solenoid slave valves 38 with associated drivers 46 may be enclosed in a separate and distinct housing 80′ so long as the computer readable medium 42 can connect to the driver 46 of the valve 38. This embodiment is particularly advantageous when an irrigation system is already in place, and it is not yet necessary to remove either the conduits 10, 22 and/or the latching solenoid slave valves 38 with associated drivers 46. In such instances, it is advantageous to be able to merely provide a waterproof enclosure 80 which encloses only one leg of a tee fitting 74 which is already in place. As shown in FIG. 15, in this embodiment, the enclosure 80 would then house at least the irrigation controller via a computer readable medium 42, a sensor 14 and a power source 26.

As also discussed above, the present invention is not limited to use of pressurized pulse generators 6. It is also possible to use a series of optical pulses transmitted through the conduit 10 to transmit data, using light transmitters 6 in conjunction with light detectors and/or fluorescent or phosphorescent materials and associated detectors 14. Using this technique, the frequency based visual device 6 generates an optical signal in the fluid or along the conduit 10.

As shown in FIG. 15, the light detector or equivalent frequency sensing device 14 is mounted on a diaphragm 36 or some other feature which directly interacts with the medium in the conduit 10, 18. The detector 14 communicates with the controller 42 either directly or via an amplifier. Again, the benefit of this arrangement is optimized when providing power 26 at the master box 20 is not a limiting factor. Another benefit of this arrangement is the capability of utilizing commercially available optical sensors 14 which enable recharging through optical signal receipt such that there would be no need to replace the batteries 26 of the slave valve 12 with the same alacrity of other embodiments. Furthermore, so long as any potential shift in frequency is accounted for, this embodiment may also provide more accurate readings regardless of air pockets which may develop and otherwise hinder transference of a physical pressure based pulse.

Slave Valve: Sensor Location and Orientation

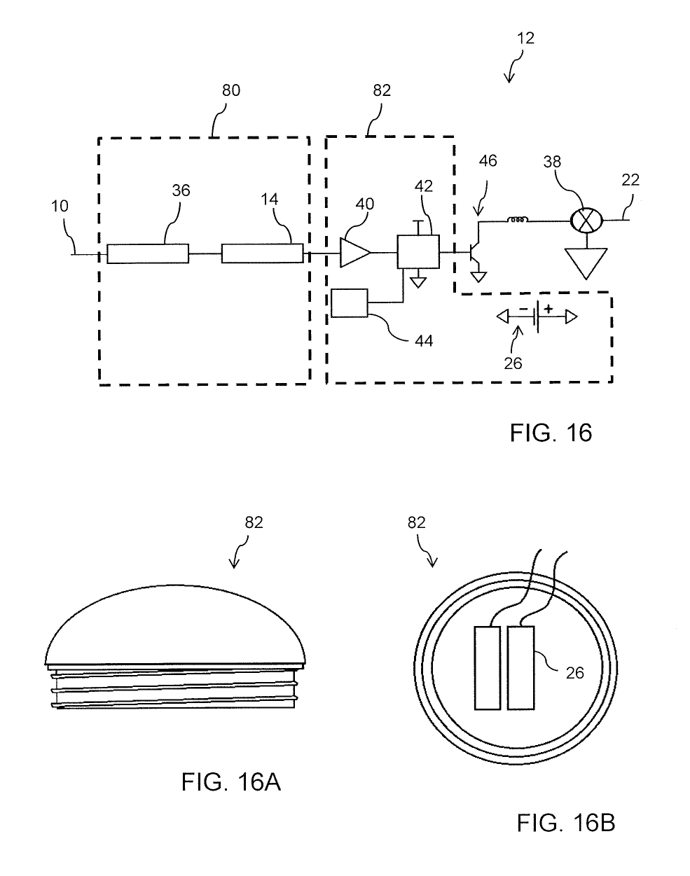

As stated previously, there are many various embodiments for the slave valve 12 according to the present invention. FIG. 16 schematically shows an outline of how these components as discussed above may be connected. It is noted that the design of the sensor and its position relative to the fluid path is critical to achieving and sustaining reliable operation. The entire diaphragm surface that contacts the fluid path, bourdon tube opening to the fluid path, or their equivalent for other technologies, should be located below the main fluid path entering and exiting the Zone to ensure that no air can get trapped at the fluid side of the sensing surface within the valve.

The design of the sensor and its orientation relative to the fluid path is critical to achieving and sustaining reliable operation. The entire diaphragm surface that contacts the fluid path, bourdon tube opening to the fluid path, or their equivalent for other technologies, should be oriented ‘face up’ relative to the main fluid path to ensure that no air can get trapped at the fluid side of the sensing surface.

Removable Cap: Either Master or Slave Valve

Referring again to FIG. 16, as well as the previous discussions of the general illustrations of FIGS. 1-6, in which each of the housings 80 also had an associated cap 82. This removable cap 82 is diagrammatically illustrated in FIGS. 16, 16A and 16B. Specifically, FIG. 16A is a diagrammatic drawing showing a side view of the removable cap with seal and threading engagement according to the present invention, while FIG. 16B is a diagrammatic drawing showing the bottom view of the removable cap with an integrated power source according to the present invention. While the following discussion is provided with reference to the cap 82 for the slave valves 12, it is to be appreciated that similar caps 82 may be employed for the main control box housing 80 with the appropriate substitutions thereto.

Removable Cap: Integral Power Source

The Zone Valve 12 electronics include the pressure/signal sensor 14, the down-stream sensing electronics, e.g., signal amplifier 40, processor 42, memory 44 and power source 26. The zone valves are self powered independently from one another and from the master valve. The power source consists of batteries that may or may not be supplemented by an external charging source, solar cell, turbine driven by fluid motion during irrigation, etc. Despite the fact that these devices are designed for years of unattended operation, the batteries will ultimately fail and require replacement. Based on the operating requirements placed on the batteries, i.e., providing high output current while opening and closing the latching valve, multi-year life, high charge storage density, etc., common, off-the-shelf batteries will typically not be adequate. It is essential to the success of the product that battery replacement be quick, foolproof and inexpensive. This includes ensuring that the proper batteries 26 are always used as replacements for the original batteries 26.

One means to satisfy the battery replacement objectives is to locate the batteries 26 in a removable, enclosure that can quickly and easily be removed and installed by the customer. This can be achieved by integrating the batteries 26 into a threaded ‘cap’ 82, or any equivalent that provides a water-proof seal and can easily be replaced by the customer.

The removable cap 82 can include operator replaceable batteries 26 which are removable from the cap 82. Thus, after removing the cap 82, the batteries 26 may be removed and new batteries 26 may be replaced within the cap 82 before the cap 82 is replaced back on the enclosure.

Removable Cap: Sensing Electronics

The removable cap 82 can also include operator replaceable batteries 26 and the down-stream sensing electronics. That is, the down-stream sensing electronics may be integrated and/or housed in the cap 82 itself. This embodiment advantageously facilitates ease of access to the sensing electronics. In the case of normal wear and tear, various electronics may be assessed and/or replaced without requiring removal of the entire tee fitting of the slave valve 12. This embodiment would preferably provide replaceable batteries 26 which are removable from the cap 82. Thus, after removing the cap 82, the batteries 26 may be removed and new batteries 26 may be replaced within the cap 82 before the cap 82 is replaced back on the enclosure.

Removable Cap: Power Source & Electronics

The removable cap 82 can include operator replaceable batteries 26 and all electronics including the down-stream sensing electronics and the pressure sensor. That is, the removable cap 82 itself comprises the entirety of the down-stream sensing electronics, the sensors, and the batteries 26 integrated and/or housed in the cap 82 itself. Again, this embodiment would preferably provide replaceable batteries 26 which are removable from the cap 82. Thus, after removing the cap 82, the batteries 26 may be removed and new batteries 26 may be replaced within the cap 82 before the cap 82 is replaced back on the enclosure.

Removable Cap: Integral Power Source

The removable cap 82 can include captive batteries 26 making the cap 82 and batteries 26 disposable. One benefit of this for the manufacturer is that consumers would have to buy the batteries 26 and integrated cap 82 provided by the manufacturer. On benefit for the client is that by making the cap 82 disposable, there is less chance of wear and tear developing along the seal of the cap 82. That is, the down-stream sensing electronics and sensor are better protected from the elements. Thus, while initially more expensive, the system will have a longer life-span.

Removable Cap: Power Source & Sensor

The disposable, removable cap 82 can include captive batteries 26 and the down-stream sensing electronics.

Removable Cap: Power Source & Electronics

The disposable, removable cap 82 can include replaceable batteries 26 and all electronics including the down-stream sensing electronics and the pressure sensor.

Pulsing Scheme, Communication, and Logic Flow Diagram

It is to be appreciated that designing the pulse encoding protocol to include a preamble consist of multiple sequential pulses of a fixed duration permits the zone controller to ‘lock’ onto and synchronize with the pulse stream originating from the master controller and decode the subsequent pulsed information. Additionally, including a sufficient pulse-to-pulse time tolerance allows the zone controller to detect robustly and decode pressure pulses whose amplitude and pulse width are distorted by the non-linear conduit pathways or stubs off the main conduit leading to the sensors and/or zone valves.

The messaging between the master and the slave valves, by definition, includes variable data, e.g., slave address information in order to differentiate one slave valve from another, variable irrigation time, etc. To gain the benefits of increasingly robust communication based on pulse-to-pulse timing tolerances where variable times are also required, requires the inclusion of an independent check mechanism. One technique of incorporating such a check mechanism is to follow each variable length parameter, i.e., variable pulse-to-pulse time, with a known fixed pulse to pulse time. Detection of a known pulse-to-pulse time that falls within the specified tolerances, immediately following a variable pulse-to-pulse time, is one mechanism of confirming, with a reasonable high probability, that the prior detected pulse time is valid. This, coupled with the requirement that all prior and subsequent fixed pulse-to-pulse times satisfy their respective specified tolerances yields a high degree off confidence that the entire pulse message, received by the slave valve, is valid.

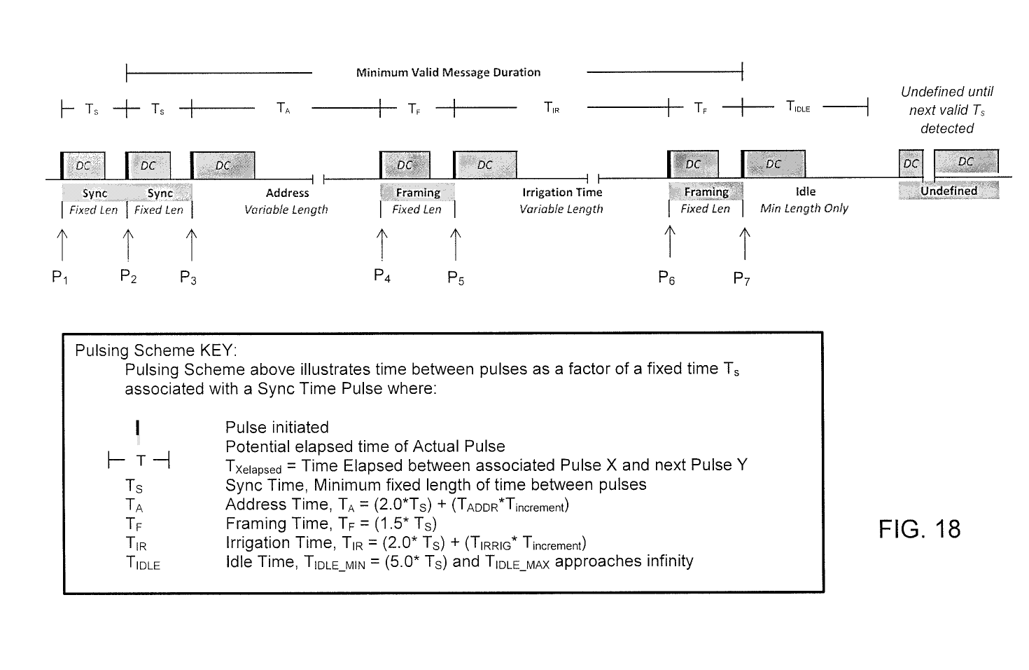

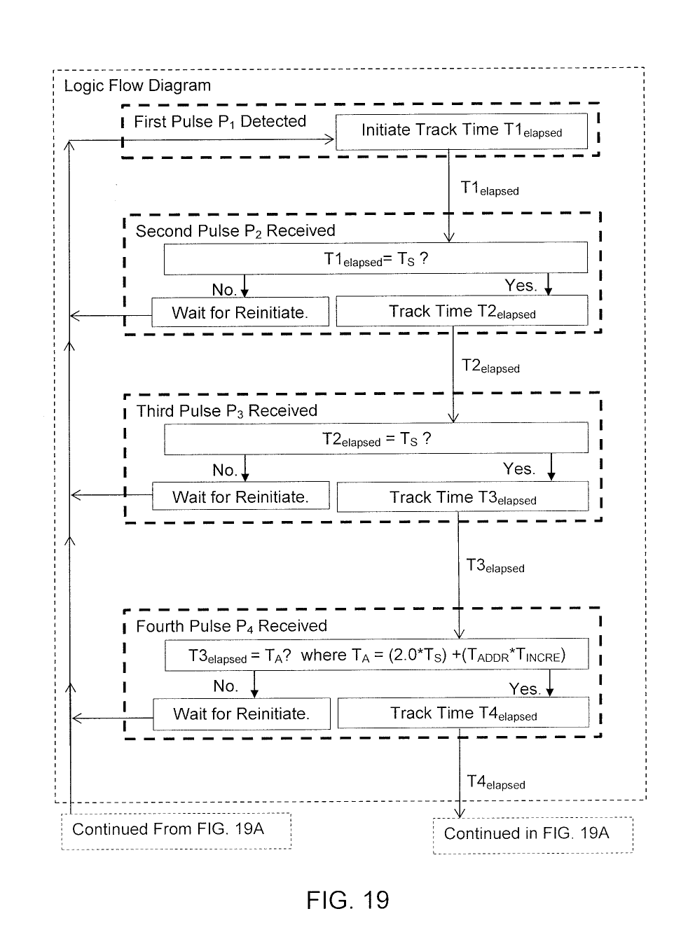

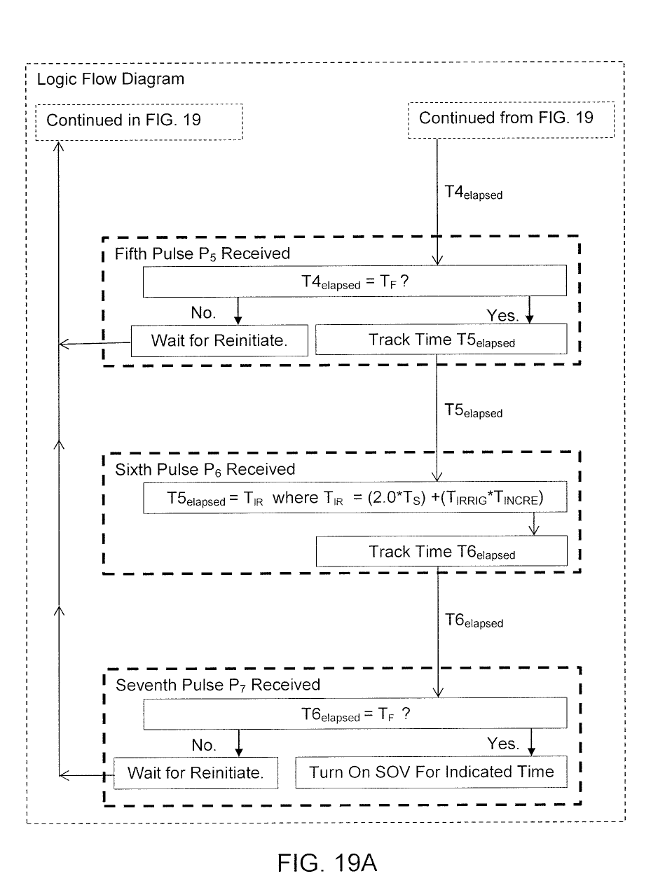

A possible communication flow chart for the software employed with the present invention is diagrammatically illustrated in FIG. 17. Diagrammatically illustrated in FIG. 18 is a possible pulsing scheme for actuating a further latching solenoid slave 12 which takes into account an actual elapsed time of the pulse itself, so as to ensure that no pulse signal can overlap with another pulse signal. FIGS. 19 and 19A together illustrate an associated logic flow diagram for possible software of the present invention.

In the pulsing scheme shown here, the difference between an actual pulse time and the time elapsed between an initiation of a pulse Pₓ and an initiation of a following pulse P_{y} is illustrated. That is, each of the preprogrammed actions is associated not with a pulse per se, but with a preprogrammed time between pulses, e.g., first and second sync times T_{S}, address time T_{A}, first and second framing times T_{F}, irrigation time T_{IR}, and idle time T_{IDLE}. Each of these preprogrammed times between pulses, e.g., first and second sync times T_{S}, address time T_{A}, first and second framing times T_{F}, irrigation time T_{IR}, and idle time T_{IDLE}, are generated by the master (pulser) valve 6 according to a master timer. Each of these preprogrammed times between pulses, e.g., first and second sync times T_{S}, address time T_{A}, first and second framing times T_{F}, irrigation time T_{IR}, and idle time T_{IDLE}, are, in turn, measured by a respective micro-counter and/or micro-timer associated with each of the slave valves 12.

Further, each of the preprogrammed times are measured from an initiation of an associated first pulse Pₓ, as measured by a leading or rising edge condition interpreted by the accelerometer, and an initiation of an associated second pulse P_{y}, as measured by a second rising edge condition interpreted by the accelerometer. For example, in FIG. 18, the first sync time Tₛ is the elapsed time T_{elapsed} between an initial detection of the first pulse P₁ and an initial detection of a second pulse P₂ by the accelerometer of the associated slave valve 12. After the first pulse P1 in the pulse sequence, each pulse provides two pieces of information:
1) when to stop tracking an elapsed time T_{X}_{_}_{elapsed}, and
2) when to start tracking a new elapsed time T_{Y}_{_}_{elapsed}.

Another feature of the scheme or pulse sequence diagrammatically illustrated in FIG. 18 is a fixed minimum elapsed time T_{MIN}_{_}_{elapsed}, between valid pulses P1, P2, P3, P4, P5, P6, P7 which is greater than a maximum actual elapsed time T_{DC} of the pulse itself, according to the formula:

T_{MIN}_{_}_{elapsed}>T_{DC}

That is, the timer within each slave valve tracks a theoretical minimum time period T_{DC} associated with an actual elapsed time between pulses. Accordingly, pulse detection of the master valve 6 is disabled for at least some time period, e.g., 80% to 90% of the theoretical minimum time period T_{DC}. This filters out acoustic reflections and extraneous pulse noise.

For example, if a theoretical minimum time period T_{DC}=0.9 seconds, then a rising edge condition initiates the timer which in turn disables pulse detection by the master valve 6 for up to 0.9 seconds. After 0.9 seconds, pulse detection is re-enabled. It is noted that all times generally have a tolerance of +/−T_{TOL} where T_{TOL} is a percentage of the minimum pulse time or pulse increment time as appropriate, e.g., 2%. Generally, no assumptions may be made regarding actual high or low pulse times. However, if no secondary pulse is detected by the microcontroller of the slave valve 12 within a theoretical maximum time period T_{MAX}, error is assumed and the microcontroller of the slave valve 12 restarts looking for a valid pulse series.

Specifically, in the pulse scheme shown in FIG. 18, the sync time Tₛ is a fixed time which indicates a start of a new message from the master valve 6, and the sync time T_{S} is also the minimum length of time which can occur between pulses, so that:

Tₛ=T_{MIN}_{_}_{elapsed}

Tₛ>T_{DC}

In this embodiment, the master valve 6 sends a minimum of two sync pulses, e.g., first and second pulses P1, P2 followed by respectively associated first and second syncing times T_{S}. Generally, the first syncing time period Tₛ and the second syncing time period Tₛ are equivalent and in a range of 1.0 to 5.0 seconds in increments of 0.5 seconds.

These sync pulses P1, P2 and associated sync times Tₛ confirm the validity of the message and instructions about to be received—thereby preventing erroneous initiation of the slave valves 12 and preserving future battery life. As shown in FIG. 18, if the elapsed time after a first erroneous acoustic pulse does not equal the sync time Tₛ, the slave valve 12 rests and/or continues measuring subsequent elapsed times until a valid sync pulse series P1, P2 and associated sync times Tₛ are detected.

Following receipt of a valid sync pulse P1, P2 having an associated sync time Tₛ, a valid pulse stream can contain either another sync pulse P2 and associated sync time Tₛ or an initiating address pulse P3 with associated address time T_{A}. Similar to the previous embodiments then, the elapsed time T_{A} is a variable period of time between the first instructional pulse and the second instructional pulse, e.g., the elapsed time between the third pulse P3 and the fourth pulse P4. This elapsed time, i.e., Address Time T_{A}, will indicate an address, i.e., which one of the latching solenoid slave valves 12 is to commence a watering cycle, e.g., the first latching solenoid slave valve, the second latching solenoid slave valve, the third latching solenoid slave valve. Each of the respective latching solenoid slave valves 12 is designated an address as a function of time according to the formula:

T_{A}=(Tₛ*2.0)+(T_{ADDR}*T_{INCR})

where T_{ADDR} varies in a range from T_{ADDR1}=1 to T_{ADDR1}=16, and T_{INCR} is in a range of 0.25 to 4.0 seconds in increments of 0.25 seconds.

When a first microcontroller 42 is programmed with Tₛ=1 second, T_{ADDR1}=1, and T_{INCR}=0.25, and a second microcontroller 42 is programmed with Tₛ=1 second, T_{ADR2}=2, and T_{INCR}=0.25, then:

T_{A}=(Tₛ*2.0)+(T_{ADDR}*T_{INCR})

T_{A1}=(1*2.0)+(1*0.25)=2.25 seconds

T_{A2}=(1*2.0)+(2*0.25)=2.50 seconds

Thus according to this scheme, if the master valve 6 sends a pulse pattern in which the third elapsed time T3_{elapsed} between issuance of the initiating address pulse P3 and the finalizing address pulse P4 is a duration of time of 2.25 seconds, then:

T3_{elapsed}=2.25 seconds

T3_{elapsed}=T_{A1}

Thus the first microcontroller 42 of the first latching solenoid slave valve 12 determines that the first latching solenoid slave valve 12 is to commence a watering cycle. On the other hand, the second microcontroller 42 of the first latching solenoid slave valve 12 also determines that the second latching solenoid slave valve 12 is not to commence a watering cycle.

Contrarily, if the master valve 6 sends a pulse pattern in which the third elapsed time T3_{elapsed} between issuance of the initiating address pulse P3 and the finalizing address pulse P4 is a duration of time of 2.50 seconds, then:

T3_{elapsed}=2.50 seconds

T3_{elapsed}=T_{A2}

Thus the first microcontroller 42 of the first latching solenoid slave valve 12 determines that the first latching solenoid slave valve 12 is not to commence a watering cycle. On the other hand, the second microcontroller 42 of the first latching solenoid slave valve 12 also determines that the second latching solenoid slave valve 12 is to commence a watering cycle.

As shown here, the finalizing address pulse P4 is followed by a framing pulse P_{F} which confirms the validity of the message and instructions received thereby preventing erroneous initiation of an incorrectly identified slave valve 12 and also preserving future battery life. That is, by providing a framing pulse after a preset framing time T_{F} the present pulse scheme prevents erroneous acoustic signals received after the initiating address pulse P3 from incorrectly triggering an incorrectly identified slave valve 12. As seen in FIG. 18, if the elapsed time T4_{elapsed}, T6_{elapsed} after an erroneous ending acoustic pulse does not equal the preset framing time T_{F}, then the slave valve 12 rests and/or continues measuring subsequent elapsed times until a complete valid sync pulse series is detected.

Once the irrigation controller 8 sends the appropriate framing pulse P5 to the latching solenoid slave valves 12, the irrigation controller 8 then sends further instructions concerning the duration of time that the desired latching solenoid slave valve 12 is to operate. In the pulsing scheme of FIG. 18, this is achieved by the irrigation controller 8 instructing the pulse valve 6 to generate a sixth pulse P6 after an irrigation time T_{IR}. Each of the respective latching solenoid slave valves 12 is preprogrammed with a series of irrigation time periods as a function of time according to the formula:

T_{IR}=(Tₛ*2.0)+(T_{IRRIG}*T_{INCR})

where T_{IRRIG} varies in a range from T_{IRRIG1}=1, associated with a first minimum preset programmed running irrigation time, to T_{IRRIG1}=120, associated with a final maximum preset programmed running irrigation time, and T_{INCR} is in a range of 0.25 to 2.0 seconds in increments of 0.25 seconds.

Thus, when a first microcontroller 42 is programmed with Tₛ=1 second, T_{IRRIG1}=1, T_{IRRIG2}=2, and T_{INCR}=0.25, then:

T_{IR}=(Tₛ*2.0)+(T_{IRRIG}*T_{INCR})

T_{IR1}=(1*2.0)+(1*0.25)=2.25 seconds

T_{IR2}=(1*2.0)+(2*0.25)=2.50 seconds

Thus according to this scheme, if the master valve 6 sends a pulse pattern in which the fifth elapsed time T5_{elapsed} between issuance of the initiating irrigation pulse P5 and the finalizing irrigation pulse P6 is a duration of time of 2.25 seconds, then:

T5_{elapsed}=2.25 seconds

T5_{elapsed}=T_{IR1}

Thus the microcontroller 42 of the previously identified latching solenoid slave valve 12 determines that the watering cycle is to commence for a first minimum preset programmed running irrigation time.

Alternatively, if the master valve 6 sends a pulse pattern in which the fifth elapsed time T5_{elapsed} between issuance of the initiating irrigation pulse P5 and the finalizing irrigation pulse P6 is a duration of time of 3.50 seconds, then:

T5_{elapsed}=3.50 seconds

T5_{elapsed}=T_{IR2}

Thus the microcontroller 42 of the previously identified latching solenoid slave valve 12 determines that the watering cycle is to commence for a second preset programmed running irrigation time.

Then, as shown in FIG. 18, the finalizing irrigation pulse P6 is followed by respective framing pulses P_{F} which assist and confirm the validity of the message and instructions received-thereby preventing erroneous initiation of the slave valves 12 and preserving future battery life. This prevents erroneous acoustic signals received after the initiating irrigation pulse P5 from triggering the identified slave valve 12 for an incorrect time period. As before and seen in FIG. 18, if the elapsed time T6_{elapsed} after an erroneous ending acoustic pulse does not equal the preset framing time T_{F}, the slave valve 12 rests and/or continues measuring subsequent elapsed times until a complete valid sync pulse series is detected. Only upon receipt of a final framing pulse p7 after a preset framing time T_{F} will the microcontroller 42 signal the driver and the respective slave latching valve 38 of the latching solenoid slave valve 12 to begin irrigation of an irrigation zone 19. Thereafter the indicated irrigation time, the respective microcontroller 42 will automatically shut off the respective slave latching valve 38 of the latching solenoid slave valve 12.

It is to be appreciated that either longer or shorter time intervals e.g., first and second sync times T_{S}, address time T_{A}, first and second framing times T_{F}, irrigation time T_{IR}, and the idle time T_{IDLE}, or alternative coding patterns altogether, may be utilized to transmit the desired operating time of a desired slave latching valve 12, without departing from the spirit and scope of the present invention. A derivative technique, requiring fewer pulses and less pulsing time, is to employ only the sync times, TS, address time TA and address framing time TF to address a slave valve and initiate irrigation and one of the Irrigation Cycle Termination techniques described hereinafter to have the master valve terminate the irrigation at the appropriate time.

Air Purging & Management

One of the most important requirements for reliably sensing pulses is a uniform and continuous fluid path between the master and all of the zone valves. Air pockets in the fluid path can degrade or prevent sensing because the air pockets can compress and ‘absorb’ the pulses resulting in a degraded signal (or even no signal) reaching the sensor. Initially then, the fluid path must be ‘bled’ to purge all air from the fluid path. This is typically performed in the traditional manner, opening the Master input valve and the last zone valve in the fluid path for a time sufficient to purge the air from the main fluid path.

This process is then supplemented by closing the first zone valve and progressively opening each zone valve one-at-a-time from the second to the last to purge any air that may be trapped between the main fluid path and the zone sensor. This purging process is typically only required at installation and at start-up after the fluid path has been flushed out at the end of the season in cold climates. However, due to pipe cracks, joint leakage and other real-word factors that will be encountered, remedial measures are required to maintain a uniform and continuous fluid path between the master and all of the zone valves. In addition, several unique design factors are necessary to sustain reliable operation.

Automatic Pressurization

It is likely that, over time, the main fluid path will experience leaks. Slow leaks are typically of little consequence during irrigation. However, when the system is not actively irrigating, the master maintains the main input valve to the water source in the Off state. When a leak permits the pressure to escape from the fluid path while the main input valve is Off, the pressure loss can be great enough to permit air to enter the fluid path and compromise sensing reliability. Consequently, including a pressure sensor in the master valve to detect leaks permits the Master valve to open the main input valve as required to maintain pressure in the fluid path and keep air out.

The master valve can monitor the frequency and duration of pressurization and provide that information to the operator so that excessive leaks can be promptly addressed.

Communication During Irrigation

The pulse encoding system is designed to minimize the possibility of a false zone valve activation, i.e., a zone valve starting in response to the decoding of random noise in the system as a valid message. The only time during which random noise of a sufficient amplitude to be detected can occur is during irrigation by a zone that decoded a valid message that included its address and as well as the synchronization and framing pulses in the correct sequence and within the correct time tolerances. All zones are programmed to decode all messages for all zone addresses and to terminate subsequent sensing and decoding while any other zone is actively irrigating. This ‘down-time’ eliminates false zone activation by prohibiting sensing and decoding during time at which random noise is generated. However, a consequence of the down time (and the fact that pulsed messages cannot reliably be transmitted during active irrigation due to the random noise generated at that time) is that the standard messaging protocol does not include any means of aborting an irrigation cycle that has already started. Therefore, a method outside of the standard messaging protocol is required to prematurely terminate an active irrigation cycle.

Irrigation Cycle Termination

When the master valve is has initiated an irrigation cycle and the addressed zone valve is open, the master can terminate the active irrigation cycle by closing the main input valve. The closed value reduces the pressure within the fluid path which serves as a termination signal to the active zone that continuously monitors fluid the pressure during the irrigation cycle. When the active zone detects the pressure drop response resulting from the closure of the main input valve, it immediately closes its open valve, terminating the irrigation cycle. The master detects the flow stoppage resulting from the zone valve closure and reopens the main input valve long enough to restore full pressure to the fluid path. All zones, including the previously inactive zones, detect the previous pressure drop. Following this detection and the subsequent restoration of pressure, the all zones activate their sensors and messaging from the master box to the zones can resume.

An alternative to closing the main input valve, to signal termination of an active irrigation cycle, consists of the master generating a low-pressure pulse of sufficient duration using the pulser valve. When an actively irrigating zone detects a pressure drop of sufficient magnitude and duration, it immediately closes the associated “open” valve, thereby terminating the irrigation cycle. This technique has the benefit of maintaining pressure in the conduit while still terminating an irrigation cycle.

The myriad ways of connecting the main conduit, between the master and slave (zone) valves inevitably, result in reflections of the pressure pulses that, purely from a pressure perspective, can be indistinguishable from intentional pressure pulses originating from the master controller and its pulser valve. These reflections are dependent on numerous physical factors including, but not limited to, the incoming fluid pressure, the pulse energy that is also dependent upon the pulsing valve orifice size, opening and closing response times, subsequent pulse width, conduit length, conduit topology, etc.

Several techniques can be employed to differentiate intentional encoded message pulses from unintended reflections or ‘noise’ pulses. The most straight forward technique resides in the pulse encoding technique employed. Designing the pulsed communications protocol, hardware and software to respond only to the time between successive pulses, as opposed to pulse width, is a critical dimension of a robust signaling and communication system since the speed of sound, i.e., a pressure wave traveling through the fluid, is constant. In contrast, basing the protocol exclusively on pulse width and/or amplitude can result in compromised pulse integrity based on the fluid pressure, conduit length, diameter, stiffness, topology and other physical factors. Basing the message encoding and decoding on the time from the leading edge of one pulse to the leading edge of the next pulse eliminates many of the challenges associated with detection of a specific pulse width. Note, using trailing edge to trailing edge detection is equivalent.

The minimum pulse-to-pulse time should be selected such that it exceeds the maximum time required for pressure reflections and other unintended noise pulses to dissipate to an insignificant level via natural damping. This time is dependent upon the incoming fluid pressure, the pulsing valve orifice size, the pulse width, the conduit length and the conduit topology.

Additionally, a zone controller pulse detection, that is designed to ignore any pulse width that does not exceed a minimum pulse width time, filters out reflected and/or unintended pulses. Also, implementing the zone pulse detection system to ignore any pulse that does not exceed a minimum specified pulse amplitude threshold is useful in disqualifying many of the lower energy reflections and noise for consideration as a valid pulse. In addition, designing the pulse detection and decoding to ignore any pulse that occurs within a specified timing window, following detection of the preceding ‘valid’ pulse, eliminates high energy reflections and allows for system damping to eliminate unintended pulses.

In a preferred implementation, the master periodically sends out a series of pulses at pre-defined intervals that each slave valve uses to calibrate itself relative to nominal fluid pressure, pulse-to-pulse timing, minimum pulse width associated with ‘valid’ pulses, and minimum pulse amplitude associated with ‘valid’ pulses. Each slave valve uses these ‘sensed’ values to detect and decode all subsequent pulses until the next calibration sequence is detected.

Computer Readable Mediums

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

It will be appreciated from the above that the invention may be implemented utilizing computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented utilizing various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

### Scope of the Invention

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed as limiting.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

Wherefore, I/we claim:

1. An irrigation system having:
a user interface;
a master valve;
at least one conduit coupling the master valve with the at least one slave valve; and
a communication system for wirelessly communicating operating instructions between the master valve and the at least one slave valve;
wherein a medium of the communication system, for transmitting instructions, is contained with and located along the conduit which couples the master valve and the at least one slave valve with one another.

2. The irrigation system according to claim 1, wherein the communication system comprises a pressure creating device and a pressure sensing device; and the operating instructions are transmitted, via pressure signals, through the conduit coupling the master valve with the at least one slave valve with one another.

3. The irrigation system according to claim 1, wherein the communication system comprises an audible signal creating device and an audible signal sensing device; and
the operating instructions are transmitted, via audible signals, through the conduit coupling the master valve with the at least one slave valve with one another.

4. The irrigation system according to claim 1, wherein the communication system comprises an optical signal creating device and an optical signal sensing device; and
the operating instructions are transmitted, via optical signals, through the conduit coupling the master valve with the at least one slave valve with one another.

5. The irrigation system according to claim 2, wherein the irrigation system includes an encoding/decoding scheme that uses pressure-pulse-to-pressure-pulse times in order to convey information from the master valve to the at least one slave valve.

6. The irrigation system according to claim 5, wherein the encoding/decoding scheme includes a data encoding/decoding scheme that uses pressure-pulse-to-pressure-pulse times to convey information from the master valve to the at least one slave valve.

7. The irrigation system according to claim 5, wherein the encoding/decoding scheme includes a synchronization preamble and an encoded data sequence that include one of fixed and variable information, where each piece of information of the is conveyed as a succession of pulse-to-pulse times.

8. The irrigation system according to claim 5, wherein each of the at least one slave valve employs pulse processing that includes at least one of a minimum pulse width detection, a minimum pulse amplitude detection, and a pulse amplitude minimum and maximum detection in order to differentiate a valid pulse from an invalid pulse.

9. The irrigation system according to claim 5, wherein the master valve and the at least one slave valve evaluate self-calibration pulses for pressure, pulse width, pulse amplitude and/or pulse delay calibration.

10. The irrigation system according to claim 5, wherein the communication system includes a designated time during which the selected slave valve can prematurely initiate irrigation and, by so doing, signal the master valve that an exception or error condition exists a selected one of the at least one slave valve.

11. The irrigation system according to claim 10, wherein the error condition is a low battery condition of the at least one slave valve.
